(19) United States
(12) Patent Application Publication
(10) Pub. No.: US 2006/0045476 A1
(43) Pub. Date: Mar. 2, 2006

(54) System and method for audio/video recorder with play list pre-editor

(76) Inventor: Emily Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/211,454

(22) Filed: Aug. 26, 2005

(30) Foreign Application Priority Data
Aug. 27, 2004 (TW) 93125738

(51) Int. Cl. H04N 5/783

(52) U.S. Cl. 386/69; 386/70

(57) ABSTRACT

The present invention provides an audio/video recording system with a play list pre-editor and method thereof. The audio/video recording system with a play list pre-editor comprises a pre-editor module for editing a record list comprising parameters of audio/video programs, wherein said audio/video programs are classified into a plurality of play lists according to play list identifications in said parameters, and a record module for recording said audio/video programs according to said parameters. Furthermore, said play lists are created for classifying said audio/video programs, and each of said play lists is used for presenting a portion of said audio/video programs with an identical play list identification. Moreover, an audio/video recording method with a play-list pre-editing capability comprises editing a record list comprising parameters of audio/video programs, wherein said audio/video programs are classified into a plurality of play lists according to play list identifications in said parameters, and recording said audio/video programs according to said parameters, and creating play lists for classifying said audio/video programs. Each of said play lists is used for grouping a portion of said audio/video programs with an identical play list identification.

### BACKGROUND OF THE INVENTION

1. Field of the Invention

The present invention generally relates to an audio/video recording system and method, and more particularly to an audio/video recording system and method with play list pre-editor.

2. Description of the Prior Art

The audio/video recording systems such as DVD (Digital Versatile Disc) recorders, DV (digital video) recorders, and computer recording software are widely used in modern life. Gradually, these recording systems are digitalized, and non-linear media are also adopted extensively in these recording systems. More and more audio/video programs can be stored in the media with higher and higher capacities. Accordingly, most of the recording systems allow a user editing a record list that stores the recording sequence of those audio/video programs assigned by the user. Additionally, a play list which stores a playback sequence of the recorded audio/video programs might be configured or modified by the user if he/she wants to vary playback sequence indicated in the record list. Basically, the recording sequence indicated by the record list also implies a default playback sequence of those recorded audio/video programs if no further play list is made by the user.

Please refer to FIG. 1, which is a pre-recording flowchart of a conventional audio/video recording system 100. First, at step 110, a pre-recording menu is displayed by the recording system 100. Next, a record list is configured by a user at step 120, wherein the record list basically includes some parameters of the ready-for-recording audio/video programs assigned by the user. Those parameters, include but not restricted to the names, time-for-recording, and recording intervals of the assigned audio/video programs, which might be assigned and/or modified by the user by means of the user interface. Finally, after configurations for this record list, recording operations are actuated by the recording system 100 according to the parameters given in the record list so as to record those assigned audio/video programs sequentially at step 160.

In the aforementioned pre-recording process in FIG. 1, play lists cannot be edited before recording the assigned audio/video programs. In other words, the user cannot vary the playback sequence implied by the record list until the recording operations complete. For those applications that the user wants to group some certain ones from the assigned audio/video programs together for playback in sequence or recoding them into an optical disc for playback in the future, he/she should actuate a post-editing procedure to configure the required play list based on the record list. This is significantly an inefficient approach for customer usage.

### SUMMARY OF THE INVENTION

The present invention provides an audio/video recording system with a play list pre-editor and method thereof. In one embodiment, the disclosed audio/video recording system comprises a pre-editor module for editing a record list comprising parameters of audio/video programs, wherein the audio/video programs are classified into a plurality of play lists according to play list identifications in the parameters, and a record module for recording the audio/video programs according to the parameters. Furthermore, the play lists are created for classifying the audio/video programs, and each of said play lists is used for presenting a portion of said audio/video programs assigned with an identical play list identification.

In the embodiment, the parameters of the audio/video programs comprise names, recording intervals, and time for recording of the audio/video programs.

In the embodiment, the audio/video programs with the identical play list identification are recorded into an optical disc after said audio/video programs being recorded by said record module.

In the embodiment, the audio/video recording system with a play list pre-editor further comprises a playback module for playing said audio/video programs with the identical play list identification in sequence.

In another embodiment, an audio/video recording method with a play-list pre-editing capability comprises the steps of editing a record list comprising parameters of audio/video programs, wherein said audio/video programs are classified into a plurality of play lists according to play list identifications in the parameters; and recording the audio/video programs according to the parameters, and creating play lists for classifying the audio/video programs.

In the another embodiment, each of the play lists is used for grouping a portion of the audio/video programs with an identical play list identification.

In the another embodiment, the audio/video programs with the identical play list identification are recorded into an optical disc after the audio/video programs being recorded by the record module.

The construction and method of operation of the invention, however, together with additional objects and advantages thereof will be best understood from the following descriptions of specific embodiments when read in connection with the accompanying figures.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 presents a diagram showing a conventional audio/video recording system;

FIG. 2 presents a block diagram showing an audio/video recording system with a play list pre-editor according to the embodiment;

FIG. 3 presents a flowchart diagram showing an audio/video recording system with a play list pre-editor according to the embodiment; and

FIGS. 4A to FIG. 4C present exemplary diagrams showing an application of daily life record case according to the embodiment.

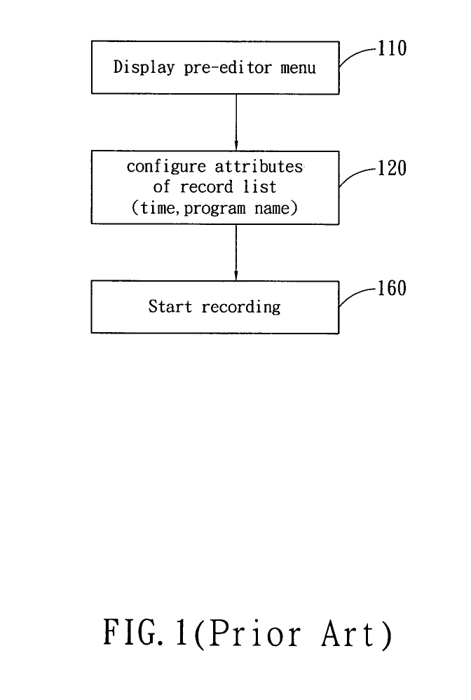

### DETAILED DESCRIPTION OF THE PREFERRED EMBODIMENTS

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

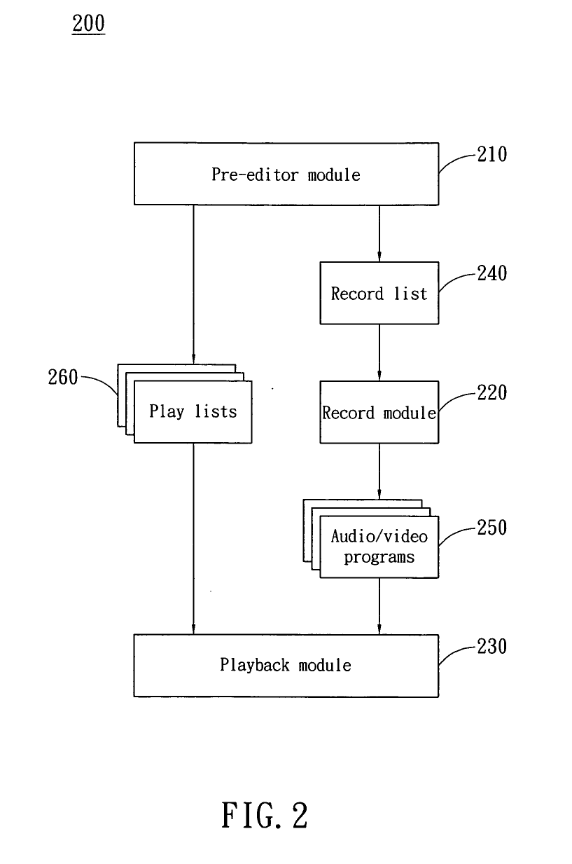

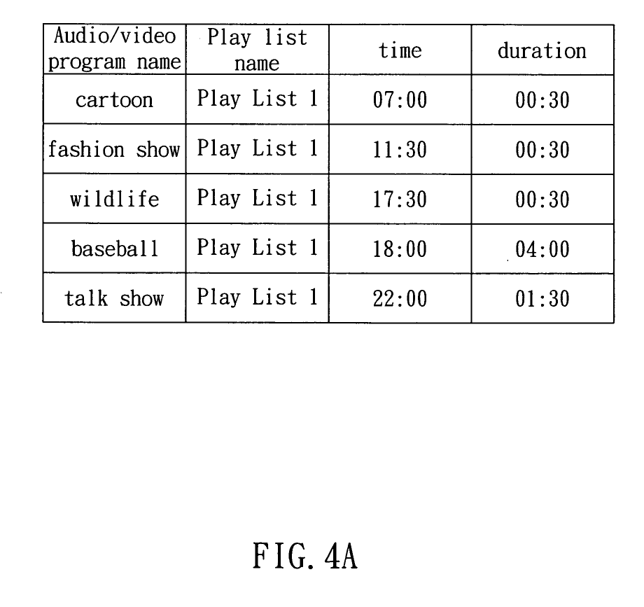

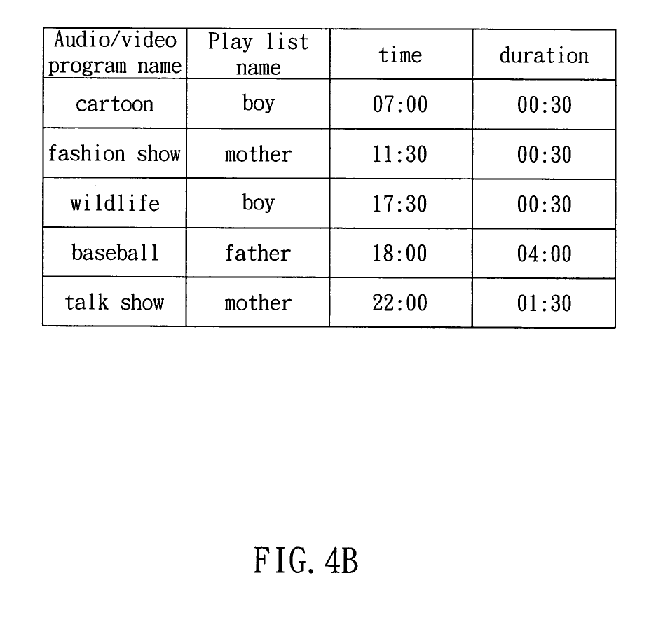

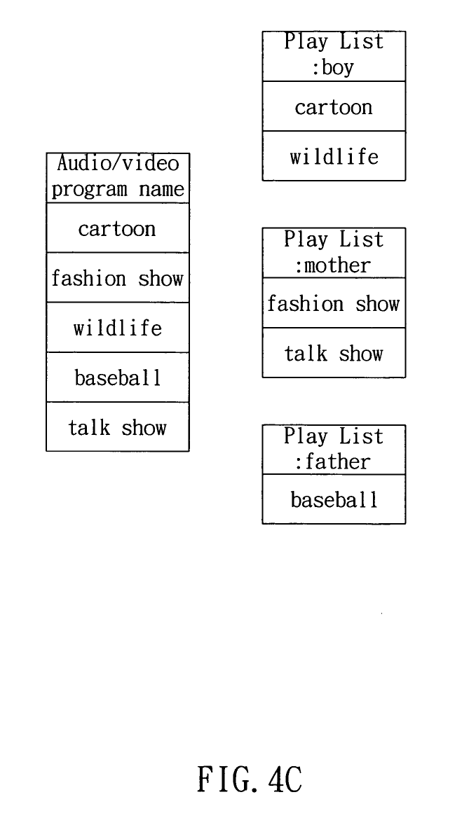

Please refer to FIG. 2, an embodiment of the present invention provides an audio/video recording system 200 with a play list pre-editor. In this regard, the recording system 200 comprises a pre-editor module 210, a record module 220, and a playback module 230. The pre-editor module 210 further comprises a user interface which can be used to edit and/or configure a record list 240. The record list 240 has some fields for presenting parameters of audio/video programs 250 to be recorded, wherein these parameters include the program names, time-for-recording, and recording intervals of the audio/video programs to be recorded. For example, in FIG. 4A, the program name such as “Cartoon”, time-for-recording such as “time”, and recording interval of the audio/video programs such as “duration” are assigned and provided by the user. The record list 240 has an introduced field entitled play list identification used for classifying the audio/video programs 250. For example, the play list identifications such as mother, father, and boy are shown in FIGS. 4A to 4C. Next, a play list 260 can be created in the pre-editor module 210 automatically so as to group or gather all desired audio/video programs together based on different play list identifications (additional descriptions are given in the following paragraphs). In the embodiment, the playback sequence of the audio/video programs 250 in the default play list 260 is identical to that in the record list 240. The user may vary and/or modify the value of the introduced field to arrange some audio/video programs having the identical play list identifications to be grouped together. Additionally, the user may play those programs having the identical play list identification in sequence, or record them into an optical disc for playback in the future. As shown in FIG. 2, the record module 220 is executed by following the parameters of the record list 240 to record audio/video programs 250 assigned by the user. The recording process to the audio/video programs are well-known to those ones having skills in the art; hence it will not be discussed in the present application.

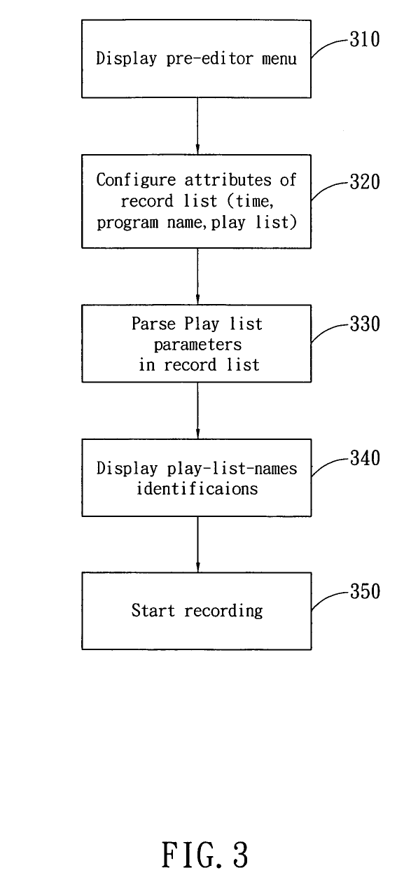

Please refer to FIG. 3, which is a flowchart diagram of a play list pre-editing method 300 in accordance with an embodiment of the present invention. First, At step 310, a user interface is provided by means of a pre-editor menu. At step 320, the parameters of the audio/video programs are assigned in a record list. In the embodiment, the record list that includes some fields for presenting parameters of audio/video programs 250 is edited by the user, wherein the parameters of the audio/video programs include but not restricted to the program names, time-for-recording, and recording intervals of the audio/video programs assigned-for-recording. At step 330, the parameters of the audio/video programs in the record list are parsed such that related play lists can be created according to the play list identifications. Hence, the play list identifications are displayed at step 340. At last, the audio/video programs assigned in the record list are recorded at step 350.

Please refer to FIG. 4A and FIG. 4B, which shows an embodiment of daily life record case in a family having a kid and parents. As usual, the father likes to watch ordinary baseball game beginning at 18:00 in every evening for four hours. Besides, the mother has to catch a fashion show starting at 11:30 in the noon for half an hour and a popular talk show starting at 22:00 in every night for one and a half hours. Moreover, the kid loves to watch a robot cartoon at 7:00 in the morning for half an hour and a big cat wildlife series before the baseball game at 17:30 in the afternoon for half an hour. Therefore, a default record list could be edited as shown in the FIG. 4A.

All of five programs to be recorded are marked as Play List 1 before activating recording operations. In this regard, the editor could mark the baseball game as a play list named “father”. The fashion show and the talk show are marked as another play list named “mother” similarly. And the cartoon and wildlife show would be classified as another play list named “boy”. All these parameters including the assigned play list identifications are shown in FIG. 4B. Once the programs are recorded, each one in the family could simply choose his/her own play list to watch without any post-recorded edition. As shown in FIG. 4C, all of five programs are categorized or classified into three different identifications of play lists such as father, mother and boy. Above all, father can select the programs of the baseball games classified in “father” play list to record into an optical disc.

Additionally, if an audio/video program assigned in the record list fails to be recorded in the step 350, the audio/video recording system 200 may amend related play list to eliminate this non-recorded audio/video program. For example, the talk show starting at 22:00 is not recorded successfully due to insufficient storage space, the audio/video recording system 200 may eliminate this audio/video program from the play list entitled “mother”. Accordingly, the mother may be notified this recording failure message and record this audio/video program again if possible (e.g. she may record this program at another time interval that replays the program).

Above all, the present invention was explained in according with embodiments. Compared with prior art, the record list having an introduced field for classifying the audio/video programs to the corresponding play list identifications can be pre-edited by the users. Hence, it is convenient for pre-editing the record list before recording audio/video programs.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An audio/video recording system with a play list pre-editor, comprising:
a pre-editor module for editing a record list comprising parameters of a plurality of audio/video programs, wherein said parameters comprises play list identifications used for classifying said audio/video programs into a plurality of play lists; and
a record module for recording said audio/video programs according to said parameters.

2. The audio/video recording system according to claim 1 further comprising a playback module for playing said audio/video programs with an identical play list identification in sequence.

3. The audio/video recording system according to claim 1 wherein said audio/video programs with an identical play list identification are recorded into an optical disc after said audio/video programs being recorded by said record module.

4. The audio/video recording system according to claim 1 wherein said pre-editor module is for creating a play list by assigning said play list identifications for said audio/video programs.

5. The audio/video recording system according to claim 1 wherein said parameters comprise names, recording intervals, and time for recording of said audio/video programs.

6. The audio/video recording system according to claim 5 wherein said record module records said audio/video programs according to said names, recording intervals, and time for recording in said record list.

7. The audio/video recording system according to claim 1 wherein order of said audio/video programs in said default play list is identical to order of said audio/video programs in said record list.

8. An audio/video recording system with a play list pre-editor, comprising:
a pre-editor module for editing a record list comprising parameters of audio/video programs, wherein said audio/video programs are classified into a plurality of play lists according to play list identifications in said parameters; and
a record module for recording said audio/video programs according to said parameters;
wherein said play lists are created for classifying said audio/video programs, and each of said play lists is used for presenting a portion of said audio/video programs with an identical play list identification.

9. The audio/video recording system according to claim 8 further comprising a playback module for playing said audio/video programs with said identical play list identification in sequence.

10. The audio/video recording system according to claim 8 wherein said audio/video programs with said identical play list identification are recorded into an optical disc after said audio/video programs being recorded by said record module.

11. The audio/video recording system according to claim 8 wherein said pre-editor module is for creating said play lists by assigning said play list identifications for said audio/video programs.

12. The audio/video recording system according to claim 8 wherein said parameters comprise names, recording intervals, and time for recording for said audio/video programs.

13. The audio/video recording system according to claim 12 wherein said record module records said audio/video programs according to said names, recording intervals, and time for recording in said record list.

14. An audio/video recording method with a play-list pre-editing capability, comprising:
editing a record list that comprises parameters of audio/video programs, wherein said parameters comprises play list identifications used for classifying said audio/video programs into a plurality of play lists; and
recording said audio/video programs according to said parameters.

15. The audio/video recording method according to claim 14 wherein said audio/video programs with an identical play list identification are recorded into an optical disc after said audio/video programs being recorded by said record module.

16. The audio/video recording method according to claim 14 wherein said pre-editor module is for creating a play list by assigning said play list identifications for said audio/video programs.

17. The audio/video recording method according to claim 14 wherein said parameters comprise names, recording intervals, and time for recording of said audio/video programs.

18. The audio/video recording method according to claim 17 wherein said record module records said audio/video programs according to said names, recording intervals, and time for recording in said record list.

19. An audio/video recording method with a play-list pre-editing capability, comprising:
editing a record list comprising parameters of audio/video programs, wherein said audio/video programs are classified into a plurality of play lists according to play list identifications in said parameters; and
recording said audio/video programs according to said parameters; and
creating play lists for classifying said audio/video programs, and each of said play lists is used for grouping a portion of said audio/video programs with an identical play list identification.

20. The audio/video recording method according to claim 17 wherein said audio/video programs with an identical play list identification are recorded into an optical disc after said audio/video programs being recorded by said record module.
